(19) United States
(12) Patent Application Publication
(10) Pub. No.: US 2010/0036804 A1
(43) Pub. Date: Feb. 11, 2010

(54) Maintained and Reusable I/O Value Caches

(75) Inventors: Thomas William Blamer, Rochester, MN (US); Wei Hu, Madison, WI (US); Kevin James Kathmann, Rochester, MN (US); Shantan Kethireddy, Chicago, IL (US); Andrew Peter Passe, Rochester, MN (US); Ulrich Thiemann, Rochester, MN (US)

Correspondence Address: IBM CORPORATION, INTELLECTUAL PROPERTY LAW;DEPT 917, BLDG. 006-1, 3605 HIGHWAY 52 NORTH, ROCHESTER, MN, 55901-7829, US

(73) Assignee: INTERNATIONAL BUSINESS MACHINES CORPORATION, Armonk, NY (US)

(21) Appl. No.: 12/185,844

(22) Filed: Aug. 5, 2008

(51) Int. Cl. G06F 17/30

(52) U.S. Cl. 707/3; 707/E17.014

(57) ABSTRACT

Embodiments of the invention provide techniques for maintaining I/O value caches for database queries. Each maintained cache may be configured for use with a particular database query. Each cache may be persistently maintained in a system, meaning the cache is not automatically deleted after some period of time, and may thus be used to process subsequent instances of the same query. By use of the maintained cache, executing subsequent instances of the query may be avoided, thus saving time and system resources. Further, the maintained cache may be adapted to process other queries having similar characteristics to the initial query. The data included in each cache may be refreshed as required by changes to the underlying data.

### BACKGROUND OF THE INVENTION

1. Field of the Invention

The invention generally relates to computer database systems. More particularly, the invention relates to maintaining and reusing input/output value caches for database queries.

2. Description of the Related Art

Databases are well known systems for storing, searching, and retrieving information stored in a computer. One type of database used today is the relational database, which stores data using a set of tables that may be reorganized and accessed in a number of different ways. Users access information in relational databases using a relational database management system (DBMS).

Each table in a relational database includes a set of one or more columns. Each column typically specifies a name and a data type (e.g., integer, float, string, etc.), and may be used to store a common element of data. For example, in a table storing data about patients treated at a hospital, each patient might be referenced using a patient identification number stored in a “patient ID” column. Reading across the rows of such a table would provide data about a particular patient. Tables that share at least one attribute in common are said to be “related.” Further, tables without a common attribute may be related through other tables that do share common attributes. A path between two tables is often referred to as a “join,” and columns from tables related through a join may be combined to form a new table returned as a set of query results.

A query of a relational database may specify which columns to retrieve data from, how to join the columns together, and conditions (predicates) that must be satisfied for a particular data item to be included in a query result table. Current relational databases require that queries be composed in query languages. A widely used query language is Structured Query Language (SQL). However, other query languages are also used.

Once composed, a query is executed by the DBMS. Typically, the DBMS interprets the query to determine a set of steps (hereafter referred to as a “query plan”) that must be carried out to execute the query. However, in most cases, there are alternative query plans that can be carried out to execute a given query. Thus, the DBMS often includes a query optimizer, which selects the query plan that is likely to be the most efficient (i.e., requiring the fewest system resources, such as processor time and memory allocation).

### SUMMARY OF THE INVENTION

One embodiment of the invention provides a computer-implemented method, comprising: receiving a first database query. In addition, the method comprises, upon determining the absence of a maintained cache specifically configured for retrieving query results in lieu of executing the first database query against a database: selecting a maintained cache, from a plurality of existing maintained caches, that is adaptable for retrieving query results in lieu of executing the first database query against the database, wherein the selected maintained cache is a currently existing maintained cache persistently residing on a storage medium and is specifically configured for retrieving query results in lieu of executing the second database query against the database, and wherein; adapting the selected maintained cache for retrieving query results in lieu of executing the first database query against the database; and executing the first database query with the adapted maintained cache.

Another embodiment of the invention provides a computer readable storage medium containing a program which, when executed, performs an operation. The operation comprises receiving a first database query. In addition, the operation comprises, upon determining the absence of a maintained cache specifically configured for retrieving query results in lieu of executing the first database query against a database: selecting a maintained cache, from a plurality of existing maintained caches, that is adaptable for retrieving query results in lieu of executing the first database query against the database, wherein the selected maintained cache is a currently existing maintained cache persistently residing on a storage medium and is specifically configured for retrieving query results in lieu of executing the second database query against the database, and wherein; adapting the selected maintained cache for retrieving query results in lieu of executing the first database query against the database; and executing the first database query with the adapted maintained cache.

Yet another embodiment of the invention includes a system, comprising: a database; a storage medium having a plurality of existing maintained caches persistently residing thereon; a processor; and a memory containing a program, which when executed by the processor is configured to perform an operation. The operation comprises receiving a first database query. In addition, the operation comprises, upon determining the absence of a maintained cache specifically configured for retrieving query results in lieu of executing the first database query against a database: selecting a maintained cache, from a plurality of existing maintained caches, that is adaptable for retrieving query results in lieu of executing the first database query against the database, wherein the selected maintained cache is a currently existing maintained cache persistently residing on a storage medium and is specifically configured for retrieving query results in lieu of executing the second database query against the database, and wherein; adapting the selected maintained cache for retrieving query results in lieu of executing the first database query against the database; and executing the first database query with the adapted maintained cache.

### BRIEF DESCRIPTION OF THE DRAWINGS

So that the manner in which the above recited features, advantages and objects of the present invention are attained and can be understood in detail, a more particular description of the invention, briefly summarized above, may be had by reference to the embodiments thereof which are illustrated in the appended drawings.

It is to be noted, however, that the appended drawings illustrate only typical embodiments of this invention and are therefore not to be considered limiting of its scope, for the invention may admit to other equally effective embodiments.

FIG. 1 is a block diagram that illustrates a client server view of computing environment, according to one embodiment of the invention.

FIG. 2 illustrates exemplary maintained caches configured for use in query optimization, according to one embodiment of the invention.

FIG. 3 is a flow diagram illustrating a method for creating a maintained cache for use in executing a database query, according to one embodiment of the invention.

FIG. 4 is a flow diagram illustrating a method for updating a maintained cache, according to one embodiment of the invention.

### DETAILED DESCRIPTION OF THE PREFERRED EMBODIMENTS

Embodiments of the invention provide techniques for maintaining I/O value caches for database queries. Each maintained cache may be configured for use with a particular database query. Each cache may be persistently maintained in a system, meaning the cache is not automatically deleted after some period of time, and may thus be used to process subsequent instances of the same query. By use of the maintained cache, executing subsequent instances of the query may be avoided, thus saving time and system resources. Further, the maintained cache may be adapted to process other queries having similar characteristics to the initial query. The data included in each cache may be refreshed as required by changes to the underlying data.

In the following, reference is made to embodiments of the invention. However, it should be understood that the invention is not limited to specific described embodiments. Instead, any combination of the following features and elements, whether related to different embodiments or not, is contemplated to implement and practice the invention. Furthermore, in various embodiments the invention provides numerous advantages over the prior art. However, although embodiments of the invention may achieve advantages over other possible solutions and/or over the prior art, whether or not a particular advantage is achieved by a given embodiment is not limiting of the invention. Thus, the following aspects, features, embodiments and advantages are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

One embodiment of the invention is implemented as a program product for use with a computer system. The program(s) of the program product defines functions of the embodiments (including the methods described herein) and can be contained on a variety of computer-readable storage media. Illustrative computer-readable storage media include, but are not limited to: (i) non-writable storage media (e.g., read-only memory devices within a computer such as CD-ROM disks readable by a CD-ROM drive) on which information is permanently stored; and (ii) writable storage media (e.g., floppy disks within a diskette drive or hard-disk drive) on which alterable information is stored. Such computer-readable storage media, when carrying computer-readable instructions that direct the functions of the present invention, are embodiments of the present invention. Other media include communications media through which information is conveyed to a computer, such as through a computer or telephone network, including wireless communications networks. The latter embodiment specifically includes transmitting information to/from the Internet and other networks. Such communications media, when carrying computer-readable instructions that direct the functions of the present invention, are embodiments of the present invention. Broadly, computer-readable storage media and communications media may be referred to herein as computer-readable media.

In general, the routines executed to implement the embodiments of the invention, may be part of an operating system or a specific application, component, program, module, object, or sequence of instructions. The computer program of the present invention typically is comprised of a multitude of instructions that will be translated by the native computer into a machine-readable format and hence executable instructions. Also, programs are comprised of variables and data structures that either reside locally to the program or are found in memory or on storage devices. In addition, various programs described hereinafter may be identified based upon the application for which they are implemented in a specific embodiment of the invention. However, it should be appreciated that any particular program nomenclature that follows is used merely for convenience, and thus the invention should not be limited to use solely in any specific application identified and/or implied by such nomenclature.

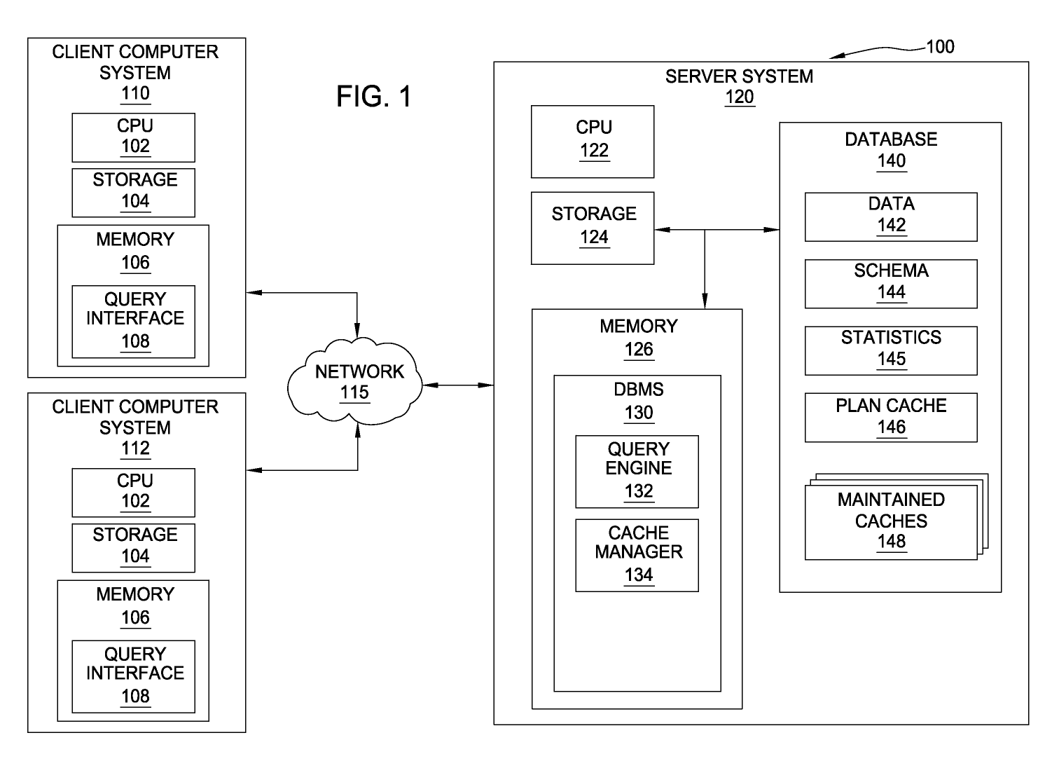

FIG. 1 is a block diagram that illustrates a client server view of computing environment 100, according to one embodiment of the invention. As shown, computing environment 100 includes two client computer systems 110 and 112, network 115 and server system 120. In one embodiment, the computer systems illustrated in environment 100 may include existing computer systems, e.g., desktop computers, server computers laptop computers, tablet computers, and the like. The computing environment 100 illustrated in FIG. 1, however, is merely an example of one computing environment. Embodiments of the present invention may be implemented using other environments, regardless of whether the computer systems are complex multi-user computing systems, such as a cluster of individual computers connected by a high-speed network, single-user workstations, or network appliances lacking non-volatile storage. Further, the software applications illustrated in FIG. 1 and described herein may be implemented using computer software applications executing on existing computer systems, e.g., desktop computers, server computers, laptop computers, tablet computers, and the like. However, the software applications described herein are not limited to any currently existing computing environment or programming language, and may be adapted to take advantage of new computing systems as they become available.

As shown, client computer systems 110 and 112 each include a CPU 102, storage 114 and memory 106, typically connected by a bus (not shown). CPU 102 is a programmable logic device that performs all the instruction, logic, and mathematical processing in a computer. Storage 104 stores application programs and data for use by client computer systems 110 and 112. Storage 104 includes hard-disk drives, flash memory devices, optical media and the like. The network 115 generally represents any kind of data communications network. Accordingly, the network 115 may represent both local and wide area networks, including the Internet. The client computer systems 110 and 112 are also shown to include a query tool 108. In one embodiment, the query tool 108 is software application that allows end users to access information stored in a database (e.g., database 140). Accordingly, the query tool 108 may allow users to compose and submit a query to a database system, which, in response, may be configured to process the query and return a set of query results. The query tool 108 may be configured to compose queries in a database query language, such as Structured Query Language (SQL). However, it should be noted that the query tool 108 is only shown by way of example; any suitable requesting entity may submit a query (e.g., another application, an operating system, etc.).

In one embodiment, the server 120 includes a processor 122, storage 124, memory 126, and a database 140. The database 140 includes data 142, schema 144, statistics 145, plan cache 146 and maintained caches 148. The data 142 represents the substantive data stored by the database 140. The schema 144 represents the structure of the elements of the database 140 (i.e., tables, fields, keys, views, indexes, etc.). The statistics 145 may include metadata describing characteristics of the database 140 (e.g., frequent values list (FVL) statistics, cardinality statistics, histogram statistics, performance statistics, etc.).

In one embodiment, the plan cache 146 may be a data structure storing query plans generated by the query optimizer, as well as auxiliary data (e.g., temporary indexes, tables, etc.) used in generating query plans. The query plans and auxiliary data stored in the plan cache 146 may be used for optimizing subsequent queries, thus reducing the amount of processing required by the cache manager 134. Further, the plan cache 146 may include historical data of past uses of the database 140 (e.g., the number of times each query has been run, the most commonly-used tables and indexes, etc.).

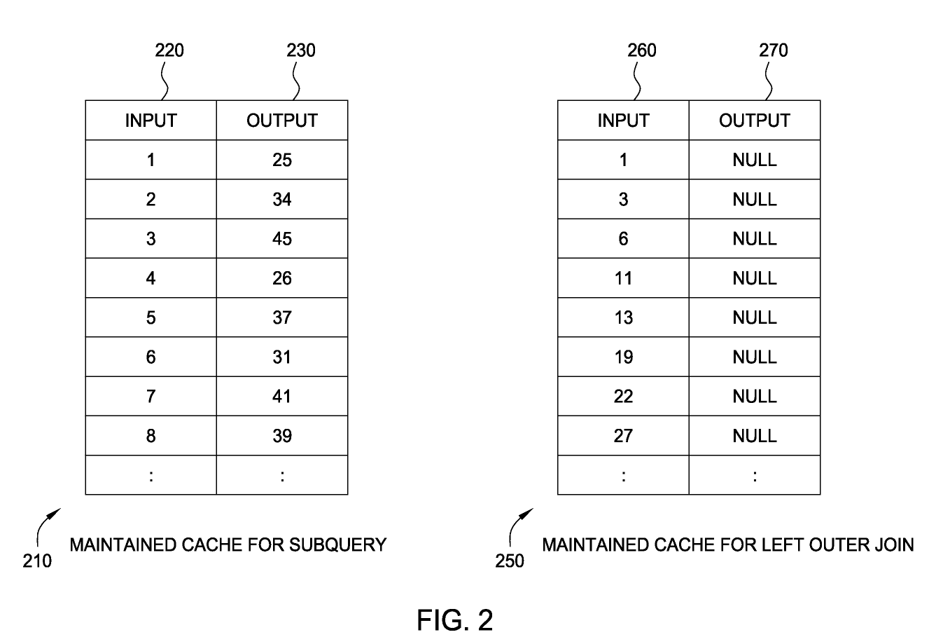

In one embodiment, the maintained caches 148 may represent multiple input/output (I/O) value cache objects, each including matched sets of inputs and output values for a given query. That is, each maintained cache 148 may include values that are used as query inputs (i.e., predicates), as well as corresponding output values from executing the query. It is anticipated that the maintained cache 250 may be used in any query that requires column data as input values and produces a single output. Examples of maintained caches 148 are described below with reference to FIG. 2.

FIG. 2 illustrates exemplary maintained caches 210, 250 configured for use in query optimization, according to one embodiment of the invention. Assume that maintained cache 210 is configured for use with a particular subquery, meaning a query used to select or filter data for a parent query. As shown, maintained cache 210 includes an input column 220, storing input values to the particular subquery, and an output column 230, storing output values to the particular subquery. That is, the rows of maintained cache 210 provides output values for executing the particular subquery with corresponding input values, without having to execute the subquery.

Assume that maintained cache 250 is configured for use with the following left outer join (LOJ) query:

SELECT*FROM T_{—}1 LOJ T_{—}2 ON T_{—}1.C_{—}1=T_{—}2.C_{—}3

For the sake of example, the LOJ query is written in the SQL query language. Generally, executing a LOJ query returns all values from the data source on the left side of the query (i.e., column C_1 included in table T_1), as well as any matching values from the data source on the right side of the query (i.e., column C_3 included in table T_2).

As shown, maintained cache 250 includes an input column 260, storing input values included in column C_1 of table T_1, and an output column 270, storing output values of the LOJ query. Note that, in this example, output column 270 does not include any LOJ values (i.e., matching values to the values in input column 260), but rather includes only NULL values. Each NULL value in output column 270 indicates that the corresponding value in input column 260 is not found in column C_3 of table T_2. In one embodiment, maintained cache 250 may be configured to only store NULL values in order to save storage space. Such a configuration may be used because, even if there is a LOJ match, the LOJ query may have to be executed in each instance of a given input value in order to determine query fanout. That is, each instance of a match in values between the two sides of the queries has to be determined by executing the query regardless of the existence of a cache object. This is required because the query results should include each instance of a match, even if it is a repeat of an earlier query result. Thus, the use of maintained cache 250 may only be of benefit to avoid query execution for input values that return NULL. Of course, it is contemplated that maintained cache 250 may also be configured to include all input values and their matching output values. Further, the maintained cache 250 may also be used to avoid execution of a left exception join, meaning a join in which the result set consists of those records in a first table for which no matching record exists in a second table. Furthermore, the maintained cache 250 may also be used to avoid execution of a deterministic user defined function (UDF) included in a query. UDFs are deterministic if they always produce the same output given the same input.

Referring again to FIG. 1, the memory 126 (e.g., random access memory) may include a database management system (DBMS) 130. The DBMS 130 provides a software application used to organize, analyze, and modify information stored in the database 140. The DBMS 130 includes a query engine 132 and a cache manager 134. The query engine 132 may be configured to process database queries submitted by a requesting application (e.g., a query generated using query tool 108) and to return a set of query results to the requesting application.

In one embodiment, the cache manager 134 may be configured to improve execution of queries using the maintained caches 148. More specifically, the cache manager 134 may use the maintained caches 148 to determine query results without having to execute the query, thus reducing the time and resources required to execute the query. Each one of the maintained caches 148 may be configured for use by a particular query.

Further, the cache manager 134 may be configured to determine whether a new maintained cache 148 should be created for use with any queries that do not have existing corresponding maintained caches 148. Such a determination may be based on a comparison of costs and benefits of the new maintained cache 148. For example, costs may include monetary expenses (e.g., licensing fees, etc.), required system resources (e.g., processor time, memory allocation, storage requirements, input and output access requirements), and the like. Benefits may include, e.g., reduced processing time resulting from not having to execute expected future instances of the received query, reduced processing time resulting from not having to execute expected future instances of queries other than the received query, and the like.

In some situations, a query may be received by the DBMS 130, and there may not be an existing maintained cache 148 that is configured for use with the received query. In such situations, the cache manager 134 may determine whether there are any maintained caches 148 that are configured for other queries, but which may be adapted to process the received query. For example, assume the DBMS 130 receives the following query:

SELECT*FROM T_{—}3 LOJ T_{—}2 ON T_{—}3.C_{—}4=T_{—}2.C_{—}3

Assume also that there is no maintained cache 148 corresponding to the received query. However, the maintained cache 250 (described above with reference to FIG. 2) is configured for use in processing a similar query, namely the following query:

SELECT*FROM T_{—}1 LOJ T_{—}2 ON T_{—}1.C_{—}1=T_{—}2.C_{—}3

Note that both queries include a left outer join (LOJ) to column C_3 of table T_2. Thus, if column C_4 of table T_3 includes some of the same values as column C_1 of table T_1, the maintained cache 250 may be used to process the received query. That is, since both LOJ queries will result in the same output values when executing the same input values, the maintained cache 250 may be used to determine the query outputs without executing the second query. In one embodiment, the cache manager 134 may be configured to determine whether a maintained cache 250 may be used to process a given query based on the frequent values list (FVL) column statistics. The FVL column statistics may be stored in the statistics 145.

In one embodiment, the cache manager 134 may determine how to configure a new maintained cache 148 for a specific use. For example, a new maintained cache 148 may be configured for use with a particular query. That is, the maintained cache 148 may include input values from data sources specified in the particular query, as well as corresponding output values from executing the particular query. Optionally, the maintained cache 148 may be configured for use with multiple queries, meaning it may combine input values from various data sources, as well as corresponding output values. Further, the maintained cache 148 data may be configured for use with a limited set of input values of a particular query. For example, the input values included in the maintained cache 148 may be limited to values included in a FVL column statistic for the particular query.

In one embodiment, the cache manager 134 may be configured to determine whether to update a maintained cache 148, meaning to refresh the stored pairs of input/output data values. Such an update is required when the underlying data source (i.e., the data source that the maintained cache 148 is based on) has been changed, thus making the maintained cache 148 invalid. For example, the data source may have been changed by a query operation (e.g., an insertion, an update, or a deletion), may have become corrupted by a processing error, and the like.

The update of a maintained cache 148 may be a complete update, meaning the entire cache is re-generated. Optionally, an update may be limited to refreshing only those values affected by the rows that have changed in the underlying data source that the cache is based on. The update may occur when the underlying data source has changed beyond a given threshold. For example, if a maintained cache 148 is generated from a database table to optimize a query, the maintained cache 148 may be updated once it is determined that more than 10% of rows of the table have been changed. In one embodiment, the update may occur at the time that the underlying data is changed. Optionally, the update may be delayed by a specified time period, such that the update process occurs at time when there is a reduced load on the computer system hosting the database. Further, the update process may occur at query optimization, meaning at the time that a query is received and is optimized for execution.

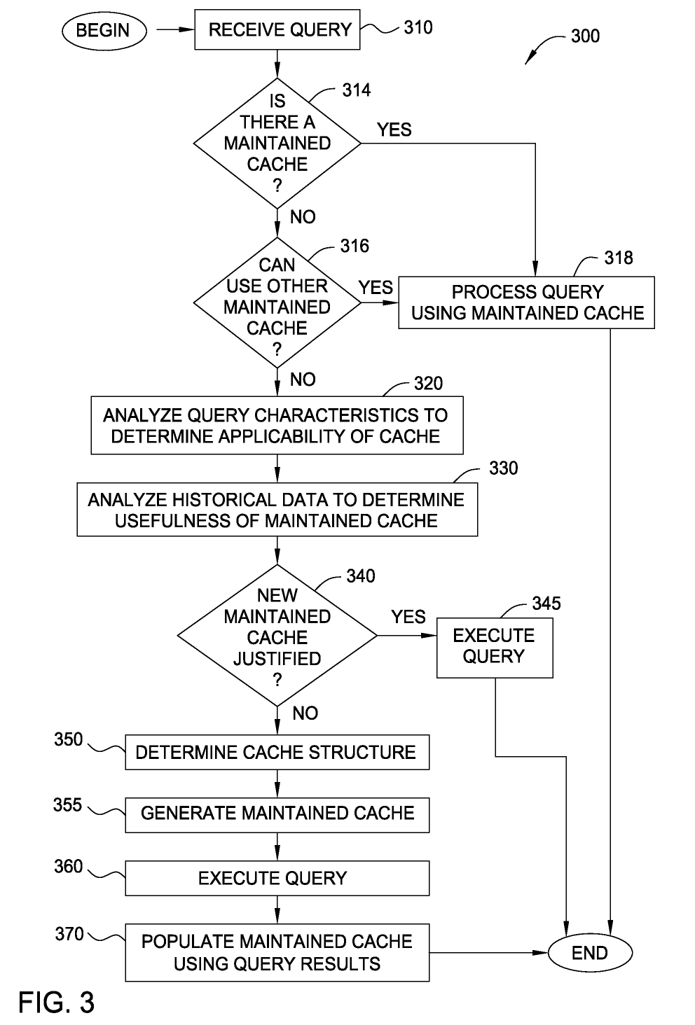

FIG. 3 is a flow diagram illustrating a method 300 for creating a maintained cache for use in processing a database query, according to one embodiment of the invention. Persons skilled in the art will understand that, even though the method is described in conjunction with the system of FIG. 1, any system configured to perform the steps of method 300, in any order, is within the scope of the present invention.

The method 300 begins at step 310, when a database query is received by a DBMS. For example, the query may be created by a user interacting with a query tool 108, and may be received by a DBMS 130 on a server system 120. At step 314, it is determined whether there is an existing maintained cache configured for use in processing the received query. For example, a cache manager 134 may determine whether one of the maintained caches 148 may be used in processing the received query. If so, the method 300 continues at step 318, where the maintained cache 148 is used in processing the received query. More specifically, query results may be retrieved from the maintained cache 148, thus avoiding having to execute the received query against the database for all input values. For example, the query engine 132 (shown in FIG. 1) may use the maintained cache 148 to process the query. After step 318, the method 300 continues at step 370, which is described further below. However, if it is determined at step 314 that there is no maintained cache 148 configured for processing the received query, then the method 300 continues at step 316, where it is determined whether there are any maintained caches 148 that are configured for other queries, but which may be adapted for processing the received query. For example, if a maintained cache 148 includes some of the same input values as the received query, it may be used to partially process the received query, meaning to retrieve some of the query results without having to execute the received query against the database for those input values. If so, the method 300 continues at step 318, where at least some portion of the maintained cache 148 is used in processing the received query.

However, if it is determined at step 316 that there is no maintained caches 148 that can be adapted for processing the received query, then the method 300 continues at step 320, where the received query is analyzed to determine whether a maintained cache 148 would be applicable for use in processing the query. For example, the cache manager 134 may be configured to analyze characteristics of the received query in order to determine whether a maintained cache 148 may be useful in processing the query. Such characteristics of the received query may include, for example, the cardinality of an input column, the selectivity of query predicates, FVL statistics, and the like.

At step 330, historical data may be analyzed to determine the usefulness of a maintained cache 148 for future queries. For example, the cache manager 134 may be configured to analyze historical data (e.g., statistics included in the plan cache 146) in order to predict the likely usefulness of a maintained cache 148 for processing future query instances. Such historical data may include the number of times that the same query has been executed in the past, which may be used to estimate the probable use of the maintained cache 148 in the future. Further, the historical data may include the number of other queries executed in the past that could have been processed using the same maintained cache 148 as the received query. Thus, the usefulness of the maintained cache 148 may be evaluated over future instances of processing the same query, as well as future instances of processing other queries that can use the same maintained cache 148.

At step 340, it is determined whether a new maintained cache 148 should be created. For example, the cache manager 134 may be configured to determine, based on the results of steps 320 and 330, whether the cost of generating and maintaining the maintained cache 148 is justified by the benefits of using the maintained cache 148 for processing future query instances. Thus, the cost of the maintained cache 148 may be amortized over future instances of processing the same query, as well as future instances of processing other queries that can use the same maintained cache 148. In one embodiment, determining whether a new maintained cache 148 is justified may also be based on a frequency of change of the underlying data that the maintained cache 148 will be based on. For example, if the cache manager 134 determines that a data source changes more often than a defined maximum frequency of change, then the maintained cache 148 may have to be refreshed too frequently to justify maintaining it. That is, the benefit of using the maintained cache 148 may be exceeded by the cost of repeatedly refreshing it.

If it is determined at step 340 that a new maintained cache 148 is not justified, then at step 345, the query is executed by the query engine 132 without using any maintained cache 148. After step 345, the method 300 terminates. However, if it is determined at step 340 that a new maintained cache 148 is justified, then at step 350, the structure of a new maintained cache 148 is determined. For example, the cache manager 134 may determine whether to include all query values used by the received query, to include a subset of query values (e.g., values included in the FVL list), to include query values used by multiple queries, to include only NULL output values (e.g., if the cache is for a LOJ query), and the like. At step 355, the maintained cache 148 is generated. For example, the cache manager 134 may generate the maintained cache 148 according to the structure determined at step 350. The maintained cache 148 may be associated to metadata describing the received query. The metadata may be used to match subsequent instances of the query to the maintained cache 148.

At step 360, the received query plan may be executed. Step 360 may be performed, e.g., by the query engine 132. At step 370, the maintained cache 148 is populated with the query results from step 360, thus preparing the maintained cache 148 for use in processing subsequent instances of the query. After step 370, the method 300 terminates.

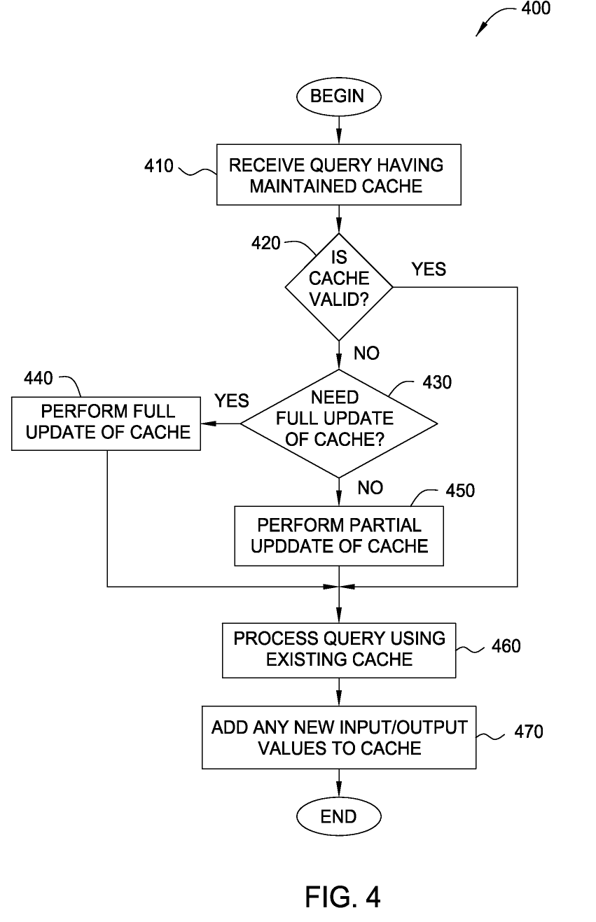

FIG. 4 is a flow diagram illustrating a method 400 for updating a maintained cache, according to one embodiment of the invention. Persons skilled in the art will understand that, even though the method is described in conjunction with the system of FIG. 1, any system configured to perform the steps of method 400, in any order, is within the scope of the present invention.

The method 400 begins at step 410, when a database query is received, and there is a maintained cache 148 configured for executing the received query. For example, a query may be created by a user interacting with a query tool 108, and may be received by a DBMS 130 on a server system 120. The server system 120 may include a maintained cache 148 configured for processing the received query. For example, the maintained cache 148 may have been created using the method 300 described above.

At step 420, it may be determined whether the maintained cache 148 is valid, meaning that the maintained cache 148 accurately reflects the underlying data upon which it is based. For example, the cache manager 134 may be configured to determine if the data sources that the maintained cache 148 is based have been changed. The changes may be due to, e.g., query operations (e.g., row update, row delete, row insert, etc.), database commands (e.g., table deletion, column deletion, etc.), or an error condition (e.g., data corruption in a table, etc.). If it is determined that the maintained cache 148 is valid, then the method 400 continues at step 460 (described below). However, if it is determined at step 420 that the maintained cache 148 is not valid, then the method 400 continues at step 430, where it is determined whether a full update of the maintained cache 148 is required. For example, the cache manager 134 may be configured to determine if the underlying data has been changed beyond some defined threshold, thus requiring a full refresh of the maintained cache 148. If so, then at step 440, a full update of the maintained cache 148 is performed. Step 440 may be performed, e.g., by the cache manager 134. However, if it is determined at step 430 that a full update of the maintained cache 148 is not required, then the method 400 continues at step 450, where a partial update of the maintained cache 148 may be performed. For example, the cache manager 134 may be configured to update only the portion of the maintained cache 148 that is affected by any changes in the underlying data. Optionally, any portions of the maintained cache 148 that are not affected by changes in the underlying data may be kept unchanged. In one embodiment, the update steps described above (i.e., step 440 and step 450) may be delayed by a specified time period, such that the update process occurs at time when there is a reduced load on the computer system hosting the database.

In one embodiment, the refresh may occur at the time that the underlying data is changed. Optionally, the refresh may be delayed to some other time, such that the refresh process occurs at time when there is a reduced load on the computer system hosting the database. Further, the refresh may occur after the time that a query is received and before it is processed using a maintained cache 148.

At step 460, the received query may be processed by the query engine 132 using the updated maintained cache 148. Additionally, any input values required by the received query that are not included in the updated maintained cache 148 may be executed by the query engine 132. At step 470, the maintained cache 148 may be updated to reflect any query results from executing the received query in the query engine 132. For example, the cache manager 134 may be configured to update the maintained cache 148 to include any new input/output values resulting from executing the received query. After step 470, the method 400 terminates.

While the foregoing is directed to embodiments of the present invention, other and further embodiments of the invention may be devised without departing from the basic scope thereof, and the scope thereof is determined by the claims that follow.

What is claimed is:

1. A computer-implemented method, comprising:
receiving a first database query;
upon determining the absence of a maintained cache specifically configured for retrieving query results in lieu of executing the first database query against a database:
selecting a maintained cache, from a plurality of existing maintained caches, that is adaptable for retrieving query results in lieu of executing the first database query against the database, wherein the selected maintained cache is a currently existing maintained cache persistently residing on a storage medium and is specifically configured for retrieving query results in lieu of executing the second database query against the database, and wherein;
adapting the selected maintained cache for retrieving query results in lieu of executing the first database query against the database; and
executing the first database query with the adapted maintained cache.

2. The computer-implemented method of claim 1, wherein executing the first database query with the adapted maintained cache comprises retrieving at least one query result from the adapted maintained cache in lieu of executing the first database query against a database.

3. The computer-implemented method of claim 1, wherein adapting the maintained cache comprises populating the maintained cache with additional data required for executing the first database query.

4. The computer-implemented method of claim 1, wherein determining a maintained cache that is adaptable for retrieving query results in lieu of executing the first database query against a database comprises determining that the maintained cache includes at least some of a set of input values required for executing the first database query.

5. The computer-implemented method of claim 1, wherein determining a maintained cache that is adaptable for retrieving query results in lieu of executing the first database query against a database comprises determining that the first database query is the same query type as the second database query.

6. The computer-implemented method of claim 5, wherein the query type of the first database query is selected from: (i) a left outer join query, (ii) a left exception join and (iii) a subquery.

7. The computer-implemented method of claim 1, wherein adapting the selected maintained cache comprises:
upon determining a requirement to update the selected maintained cache:
determining one or more characteristics of one or more data sources upon which the selected maintained cache is based;
determining, based on the one or more characteristics, a portion of the selected maintained cache to update; and
updating the determined portion of the selected maintained cache.

8. The computer-implemented method of claim 7, wherein determining a requirement to update the selected maintained cache is based on at least one of: (i) a user command, (ii) a change to the one or more data sources, and (iii) a scheduled update of the selected maintained cache.

9. The computer-implemented method of claim 8, wherein the change to the one or more data sources comprises at least one of: (i) a query operation, (ii) a database command, and (iii) an error condition.

10. The computer-implemented method of claim 8, wherein the change to the one or more data sources exceeds a predefined threshold, wherein the predefined threshold specifies a change amount requiring an update to the selected maintained cache.

11. The computer-implemented method of claim 7, wherein the determined portion of the selected maintained cache comprises one of: (i) one or more values affected by a change, (ii) one or more values included in a frequent values list, and (iii) the entire selected maintained cache.

12. The computer-implemented method of claim 7, wherein updating the determined portion of the selected maintained cache comprises one of: (i) updating the determined portion at the time of query optimization, (ii) updating the determined portion at a specified time, and (iii) updating the determined portion after a specified wait period.

13. A computer readable storage medium containing a program which, when executed, performs an operation, the operation comprising:
receiving a first database query;
upon determining the absence of a maintained cache specifically configured for retrieving query results in lieu of executing the first database query against a database:
selecting a maintained cache, from a plurality of existing maintained caches, that is adaptable for retrieving query results in lieu of executing the first database query against the database, wherein the selected maintained cache is a currently existing maintained cache persistently residing on a storage medium and is specifically configured for retrieving query results in lieu of executing the second database query against the database, and wherein;
adapting the selected maintained cache for retrieving query results in lieu of executing the first database query against the database; and
executing the first database query with the adapted maintained cache.

14. The computer readable storage medium of claim 13, wherein executing the first database query with the adapted maintained cache comprises retrieving at least one query result from the adapted maintained cache in lieu of executing the first database query against a database.

15. The computer readable storage medium of claim 13, wherein adapting the maintained cache comprises populating the maintained cache with additional data required for executing the first database query.

16. The computer readable storage medium of claim 13, wherein determining a maintained cache that is adaptable for retrieving query results in lieu of executing the first database query against a database comprises determining that the maintained cache includes at least some of a set of input values required for executing the first database query.

17. The computer readable storage medium of claim 13, wherein determining a maintained cache that is adaptable for retrieving query results in lieu of executing the first database query against a database comprises determining that the first database query is the same query type as the second database query.

18. The computer readable storage medium of claim 17, wherein the query type of the first database query is selected from: (i) a left outer join query, (ii) a left exception join and (iii) a subquery.

19. The computer readable storage medium of claim 13, wherein adapting the selected maintained cache comprises:
upon determining a requirement to update the selected maintained cache:
determining one or more characteristics of one or more data sources upon which the selected maintained cache is based;
determining, based on the one or more characteristics, a portion of the selected maintained cache to update; and
updating the determined portion of the selected maintained cache.

20. The computer readable storage medium of claim 19, wherein determining a requirement to update the selected maintained cache is based on at least one of: (i) a user command, (ii) a change to the one or more data sources, and (iii) a scheduled update of the selected maintained cache.

21. The computer readable storage medium of claim 20, wherein the change to the one or more data sources comprises at least one of: (i) a query operation, (ii) a database command, and (iii) an error condition.

22. The computer readable storage medium of claim 20, wherein the change to the one or more data sources exceeds a predefined threshold, wherein the predefined threshold specifies a change amount requiring an update to the selected maintained cache.

23. The computer readable storage medium of claim 19, wherein the determined portion of the selected maintained cache comprises one of: (i) one or more values affected by a change, (ii) one or more values included in a frequent values list, and (iii) the entire selected maintained cache.

24. The computer readable storage medium of claim 19, wherein updating the determined portion of the selected maintained cache comprises one of: (i) updating the determined portion at the time of query optimization, (ii) updating the determined portion at a specified time, and (iii) updating the determined portion after a specified wait period.

25. A system, comprising:
a database;
a storage medium, having a plurality of existing maintained caches persistently residing thereon;
a processor; and
a memory containing a program which, when executed, performs an operation, the operation comprising:
receiving a first database query;
upon determining the absence of a maintained cache specifically configured for retrieving query results in lieu of executing the first database query against the database:
selecting a maintained cache, from the plurality of existing maintained caches, that is adaptable for retrieving query results in lieu of executing the first database query against the database, wherein the selected maintained cache is specifically configured for retrieving query results in lieu of executing the second database query against the database, and wherein;
adapting the selected maintained cache for retrieving query results in lieu of executing the first database query against the database; and
executing the first database query with the adapted maintained cache.
